(19) United States
(12) Patent Application Publication
(10) Pub. No.: US 2012/0164064 A1
(43) Pub. Date: Jun. 28, 2012

(54) PROCESS FOR PRODUCING THERMALLY-INTEGRATED HYDROGEN BY REFORMING A HYDROCARBON FEEDSTOCK

(75) Inventors: Florent GUILLOU, Ternay (FR); Karine SURLA, Saint Cyr Sur Le Rhone (FR); Jean Louis AMBROSINO, Ternay (FR); Christophe BOYER, Charly (FR)

(73) Assignee: IFP ENERGIES NOUVELLES, RUEIL-MALMAISON CEDEX (FR)

(21) Appl. No.: 13/332,449

(22) Filed: Dec. 21, 2011

(30) Foreign Application Priority Data
Dec. 22, 2010 (FR) 10/05020

(51) Int. Cl. C01B 3/48; C01B 3/32

(52) U.S. Cl. 423/650; 423/655

(57) ABSTRACT

The invention relates to a process for producing thermally-integrated hydrogen by reforming a hydrocarbon feedstock, in a reforming reactor, comprising a stage for maintaining the temperature of the effluent that is obtained from the reforming reactor by co-current heat exchange, in a co-current heat exchanger, between the effluent that is obtained from the reforming reactor and the hydrocarbon feedstock that it is desired to reform. The temperature of the synthetic gas exiting the feedstock-effluent exchanger is between 250° C. and 400° C.

The invention relates to the field of the production of hydrogen by reforming a hydrocarbon feedstock.

The production of hydrogen is expanding rapidly. As a matter of fact, at the level of energy production, for example, the feedstocks of the refineries are becoming increasingly heavy, contain an increasing amount of sulfur, and require an increasing amount of hydrogen to maintain the production of fuel. This is also the case in the field of biofuels with the stepped-up hydrotreatment of vegetable oils.

Large-scale hydrogen production is most often done by natural gas vapor reforming (SMR for Steam Methane Reforming according to English terminology). This production is well-suited to important industrial consumers. By contrast, for more limited requirements, it is common to use smaller, less complex units or units that can treat a liquid feedstock that is easy to transport or to store far from the usual distribution networks.

The reforming of natural gas or light hydrocarbon feedstocks, such as short alkanes or light alcohols, is done for the sake of simplicity and savings, by autothermal reforming with air (ATR, for Autothermal Reforming according to English terminology). For ATR, it is not necessary to employ an external heat source for compensating the heating of the reagents and the endothermy of the reforming reaction, but it is necessary to have a controlled and limited air supply in the reaction medium that causes the partial and exothermal oxidation of a fraction of the feedstock and/or synthetic gas obtained from the reforming reaction. This supply of air directly affects the yield of the unit; it is thus sought to limit it as much as possible, for example by recovering heat from the effluents.

Furthermore, under the conditions of pressure and temperature at the ATR outlet and in terms of the composition of synthetic gas obtained from ATR and in particular its high carbon monoxide content, there is a risk of corrosion by “catastrophic carburation” (“metal dusting” according to English terminology) on the metal elements located downstream from the reactor over a temperature range of between 400 and 900° C. according to the nature of the material, and this is why it is necessary to lower the temperature of the effluent as quickly as possible at the ATR outlet.

These two aspects led to the use of feedstock-effluent exchangers where all or part of the feedstock, at ambient temperature, is heated, evaporated and superheated in an exchanger where the hot synthetic gas obtained from the ATR reactor circulates.

The most used configuration is the counter-current configuration. This makes it possible both to extract the maximum heat from the effluent of the ATR but also to produce a heated and/or superheated feedstock at the highest temperature possible, with the counter-current configuration making it possible to bring the feedstock and the effluent of the ATR closer together at its maximum temperature.

The patent application EP 2 107 043 that describes a system for producing hydrogen from ethanol uses a configuration of this type. The process for producing ethanol includes an ATR reactor and a recovery of the heat exiting the ATR reactor by a counter-current exchanger between the synthetic gas and a mixture of ethanol and vapor.
The use of a counter-current exchanger can sometimes pose cooling problems of the ATR effluent, particularly during transient start-up and shutdown phases or variations of cases of operation of the unit.

This invention proposes responding to these temperature-monitoring problems downstream from the ATR reactor that operates in a transient regime and more generally of gaseous effluent temperature stabilization by a particular configuration of coupling between the ATR reactor and a feedstock-effluent reactor and for distribution of the supply of water of the process. The particular coupling configuration makes it possible to ensure holding the exit temperature of the synthetic gas above a minimum level that corresponds to an intermediate temperature between the high temperature of the effluent and the low temperature of the feedstock. This makes it possible, even in the start-up or shutdown phase, to keep temperature levels close to the nominal operating conditions and therefore to protect the exchanger itself and the catalytic system located downstream.

This configuration allows an effective and reliable operation of the process even in the case of poor sizing of the exchanger.

The particular configuration of distribution of the process's water supply makes it possible to adjust the sampling of heat at different points in the system.

For this purpose, this invention proposes a process for producing thermally-integrated hydrogen by reforming a hydrocarbon feedstock, in a reforming reactor, comprising a stage for maintaining the temperature of the effluent that is obtained from the reforming reactor by co-current heat exchange, in a co-current heat exchanger, between the effluent that is obtained from the reforming reactor and the hydrocarbon feedstock that it is desired to reform.

This prevents, by design, the appearance of water condensation upstream from catalytic reactors located downstream from the reforming reactor.

According to one embodiment of the invention, the temperature of the effluent after passing into the co-current heat exchanger is between 250° C. and 400° C.

According to one embodiment of the invention, the process comprises a stage in which the reformate that is obtained from the co-current heat exchanger is purified in a purification section for generating a hydrogen gas whose purity is greater than 99%.

According to one embodiment of the invention, a portion of the purification is carried out with a reaction for converting carbon monoxide.

According to one embodiment of the invention, the process comprises the following stages:
A first stream of water is directed toward the co-current heat exchanger, making it possible to evaporate it while recovering a portion of the enthalpy of the synthetic gas that is produced,
A second stream of water is directed toward a heat exchanger downstream from the reactor for conversion reaction of carbon monoxide to recycle the exothermy of the reaction of the conversion reaction of carbon monoxide,
A third stream of water is directed toward a heat exchanger for recovery of the heat obtained from combustion smoke while reducing the exit temperature of this smoke as much as possible.

According to one embodiment of the invention, the first stream of water is brought into direct contact with the stream of the feedstock upstream from the exchanger when the feedstock is liquid.

According to one embodiment of the invention, the first stream of vaporized water is brought into contact with the stream of the feedstock downstream from the co-current exchanger and upstream from the reforming reactor when the feedstock is gaseous.

According to one embodiment of the invention, the hydrocarbon feedstock is liquid.

According to one embodiment of the invention, the hydrocarbon feedstock is ethanol and can be denatured ethanol.

According to another embodiment of the invention, the hydrocarbon feedstock is gaseous.

According to another embodiment of the invention, the hydrocarbon feedstock is natural gas.

According to one embodiment of the invention, the reforming reaction is an autothermal reforming.

According to one embodiment of the invention, the water that is contained in the hydrogen-rich gas obtained from the reforming reactor is eliminated using a condenser that is located in the purification section.

According to one embodiment of the invention, the water collected in the condenser is recycled in the process.

According to one embodiment of the invention, the water collected in the condenser is sent into the reforming reactor to be used as a reagent of the vaporeforming reaction.

According to one embodiment of the invention, the residual gases that are released by the purification section are used as fuel for the burner.

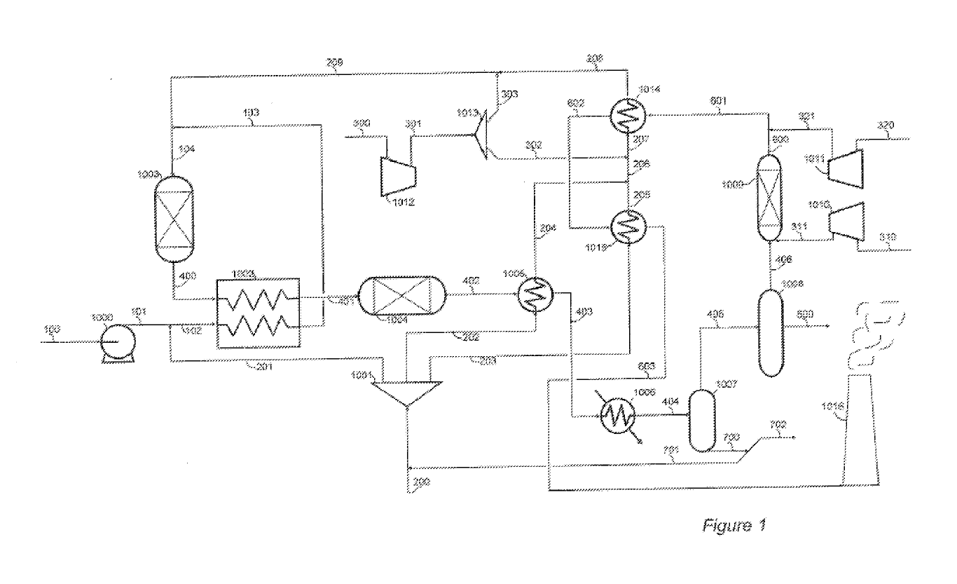

Other characteristics and advantages of the invention will be better understood and will become clearer from reading the description given below by referring to FIG. 1 that is attached and provided by way of example, which is a diagrammatic representation of the process according to the invention.

The invention is adapted to the reforming of hydrocarbon feedstocks. Preferably, the hydrocarbon feedstock is liquid or gaseous. It may be natural gas, hydrocarbons, petroleum fractions or alcohols, preferably ethanol that can be denatured or, finally, mixtures of the latter. A potentially advantageous fuel is bioethanol. This biofuel is presented as a durable energy alternative. It is obtained by fermentation or distillation of plant raw materials such as, for example, saccharose or starch. It has the advantage of having a very low greenhouse gas emission level.

In addition to the hydrocarbon feedstock, the process requires a supply of water. The latter is preferably deionized.

For the autothermal reforming reaction, an oxygen source is necessary to the reaction. The latter can be pure oxygen, air, or oxygen-enriched air.

The invention preferably uses an autothermal reforming reactor (ATR for Autothermal Reforming according to English terminology). The latter typically operates at a temperature of between 400° C. and 1000° C., and preferably less than 725° C., which is the boundary temperature that an inexpensive material can withstand. The absolute pressure is in general between 100 KPa and 4,000 KPa. The ATR reactor contains one or more catalysts that are suitably selected by one skilled in the art.

The feedstocks that are introduced into the reforming reactor are preferably heated to a temperature of between 300° C. and 500° C., preferably between 425° C. and 475° C. When the hydrocarbon feedstock is liquid, the latter can be evaporated by itself or with water and/or with air and/or with water vapor before being injected into the reforming reactor in gaseous form. It is important not to have a two-phase mixture at the inlet of the reformer because this reduces the performance levels of the reactor. The water is also vaporized by itself or with the air and/or with the hydrocarbon feedstock. At the inlet of the reformer, it is important that the temperature of the mixture remains less than the self-ignition temperature of the feedstock under the operating conditions. For example, in the case of a hydrocarbon feedstock that consists of ethanol, the temperature at the inlet of the reforming reactor is preferably less than 475° C.

The energy that is necessary for this vaporization and heating is taken at different points in the process by heat exchangers. The primary heat sources are the hot effluent that exits from the ATR reactor and the combustion gases that are obtained from the burner of residual gases.

According to one embodiment of the invention, the process comprises a co-current heat exchange stage between the effluent that is obtained from the ATR reactor, which is the synthetic gas and the hydrocarbon feedstock that it is desired to reform. The coupling of the ATR reactor with a feedstock-effluent reactor in co-current configuration makes it possible to keep the exit temperature of the synthetic gas above a minimum level that corresponds to an intermediate temperature between the high temperature of the effluent and the low temperature of the feedstock. This makes it possible, even in the start-up or shutdown phase, to keep temperature levels close to the nominal operating conditions and therefore to protect the exchanger itself and the catalytic system located downstream. This configuration makes possible an effective and reliable operation of the process even in the case of poor sizing of the exchanger.

Certain other effluents, such as that of a WGS reactor, can be employed. Good thermal integration makes it possible to reach a quite high H₂O/C molar ratio (preferably greater than 3.0, more preferably greater than 4.0), which makes it possible to reach a good hydrogen yield (preferably greater than 60%, and more preferably greater than 64%), while maintaining the autothermal process, i.e., without a supply of outside energy.

The reformate, i.e., the effluent from the reforming reactor, is a synthetic gas. It is preferably treated by a purification section. Said section can contain one or more units that make it possible to reduce the carbon monoxide level, to separate the hydrogen-rich gas, and to purify it so as to obtain a gas whose purity is greater than 99% and preferably greater than 99.95%.

Typically, a reactor for converting carbon monoxide into water is the most used means. Several catalytic conversion zones can be used to reduce the level of carbon monoxide in the reformate. Suitable catalysts are selected by one skilled in the art. At the outlet of a reactor for converting carbon monoxide into water, the volumetric percentage of carbon monoxide (CO) is generally approximately 0.5 or more. The effluent also contains water and carbon dioxide (CO₂). Since the reaction is exothermic, the heat of the effluent from the reactor for converting carbon monoxide into water is generally employed to heat other streams of the process.

The effluent from the reactor for converting carbon monoxide into water is preferably cooled by one or more exchangers, and then the remaining water can preferably be eliminated in a condenser. To limit the water content in the hydrogen-rich gas outside of the purification unit, the temperature of the mixture is preferably lowered to below 40° C. The water of the process that is recovered after condensation can be recycled.

The distribution of the supply of water of the process, which is significant in this invention, is preferably done into three different streams so as to make it possible to adjust the sampling of heat at different points of the system. The three streams of water are divided in the following manner:
A first stream of water is directed toward an exchanger, making it possible to evaporate it by recovering a portion of the enthalpy of the synthetic gas that is produced. This stream is used to control the temperature of the evaporated feedstock stream or that of the effluent from the ATR to adjust the recovery of heat. In the case of a liquid feedstock, this stream is mixed with the feedstock stream upstream from the exchanger, i.e., brought into direct contact with the feedstock (the temperature is thus controlled at the outlet of the exchanger/vaporizer by adding more or less water to the feedstock). In the case of a gas feedstock, the stream of water is injected by itself into the exchanger and is therefore used without direct contact with the feedstock that will be mixed with the vapor formed downstream from the exchanger and upstream from the ATR. In the case of a liquid feedstock, the O₂/C ratio is also adjusted, with the oxygen being obtained from the water and/or the feedstock in the feedstock/effluent exchanger. Likewise, in this case, the fraction of the water flow is calculated for limiting the pyrolysis reactions of the feedstock in the exchanger and for adjusting the temperature of the synthetic gas downstream,
The second stream of water is directed toward a heat exchanger downstream from the WGS reactor for recycling the exothermy of the WGS reaction in the process and thus for improving the yield of the unit,
The third stream of water is directed toward a heat exchanger for recovery of the heat obtained from combustion smoke while reducing the exit temperature of this smoke as much as possible.

It is possible to use another form of additional purification, such as, for example, a preferred oxidation (PrOx). In a preferred embodiment of this process, the purification section comprises a system for purification by adsorption (PSA for Pressure Swing Adsorption according to English terminology). This technology makes it possible to obtain hydrogen of very high purity (greater than 99.9% by volume) starting from a hydrogen-rich gas. The unsuitable gases that are released by this purification section, referred to as “off-gas” according to the English terminology, consist of, for example during an autothermal reforming, a portion of the hydrogen that is produced (approximately 15 mol %), hydrocarbon feedstock that is not consumed in the reaction (approximately 2 mol %), nitrogen (approximately 47 mol %), carbon dioxide (approximately 33 mol %), carbon monoxide (approximately 2 mol %), and water (approximately 1 mol %). These gases are preferably burned in a gas burner.

This catalytic gas burner is supplied with air (called primary combustion air or primary air) by a ventilation system. If the hydrogen production installation is coupled to a fuel cell, the exiting anodic and cathodic gases are also preferably used as residual gases and are burned in the burner of residual gases.

The hot effluents from the burner are used below to heat and/or to evaporate indirectly the hydrocarbon feedstock and/or the water and/or the air by means of heat exchangers.

Thus, two heat exchangers are installed consecutively to the hot stream of the effluents from the burner:
The first exchanger, closest to the burner and therefore in contact with the very hot effluents from the burner, is used to superheat a mixture of water vapor, preferably with air or the hydrocarbon feedstock in gaseous form. This mixture that is thus superheated by indirect thermal exchange is injected directly into the reforming reactor where it is used as a fuel.
The second exchanger, located downstream from the first exchanger by considering the hot stream of the effluents from the burner, and therefore in contact with these same effluents cooled by the first exchanger, is used as an evaporator. It makes it possible to evaporate a stream of liquid water or a hydrocarbon feedstock when the latter is liquid. It generates a stream of water vapor and/or vaporized hydrocarbon feedstock.

According to one version of the process, a stream of liquid water and/or liquid hydrocarbon feedstock is vaporized by the second heat exchanger, is mixed with an oxygen source, preferably a stream of air, and this mixture is superheated in the first heat exchanger. However, the circulation of the streams can be carried out in all of the different ways one skilled in the art deems possible. For example, the vaporized stream that is obtained from the second heat exchanger can be mixed with other streams before this new mixture passes through the first exchanger. It is generally preferred to have single-phase fluxes at the inlets and outlets of all of the heat exchangers.

In general, the temperature of all of the streams does not exceed 725° C., which is the maximum temperature that an inexpensive material can withstand. In addition, the distribution of heat between the two exchangers is essential primarily for two reasons:
To prevent the mixture from exiting from the first heat exchanger and reaching the inlet of the reforming reactor, it has a temperature beyond its self-ignition temperature,
So that the water stream exiting from the second heat exchanger is totally vaporized. As a matter of fact, if the vaporization is not complete at the outlet of the second exchanger, a two-phase mixture is then injected into the first exchanger, which reduces the effectiveness of the heat exchange inside this first exchanger because the distribution of the two phases in the exchanger generally is not homogeneous.

A means for monitoring the distribution of heat in the two exchangers consists in diluting the hot effluent gas of the burner by a cold stream that can be, for example, fresh air or water. The terms of cold or fresh stream refer in the text below to a stream whose temperature is less by at least 200° C. than the combustion temperature inside a burner. In a preferred way, this fresh stream has a temperature of between −10° C. and 400° C., and preferably between 0° C. and 400° C. In a very preferred way, this fresh stream is at ambient temperature. In an even more preferred way, this fresh stream is an air stream. It is mixed with hot gas from the outlet of the burner between the outlet of the catalytic zone of the burner and the first exchanger. The mixing can therefore be carried out outside of the burner or inside the burner after the catalytic zone. The flow rate of this added stream is monitored. Owing to this addition of a fresh stream to the hot effluent of the burner, it is possible to reduce the temperature of this hot effluent before its input into the first exchanger and thus to reduce the temperature difference between the hot source and the cold source of the exchanger. In this way, the heating capacity yielded by the hot mixture that is obtained from the burner in the first exchanger is reduced. However, with the flow rate of the hot mixture obtained from the burner being higher, the temperature of the superheated vaporized stream that exits from the first exchanger remains unchanged. The temperature of the hot mixture after passing into the first exchanger remains high enough to make possible the total vaporization of water and/or of the hydrocarbon feedstock when it is liquid, which is introduced into the second exchanger.

The mixture of residual gases from the purification section of hydrogen and primary combustion air is burned in the catalytic burner at approximately 900° C. The fresh stream, preferably air, injected into the effluent gas of the burner makes it possible to reduce the temperature of said effluent gas to a temperature that is less than 725° C., preferably between 600° C. and 725° C., and in a more preferred manner between 600° C. and 700° C.

A system for monitoring the temperature of the effluent gases of the burner before the addition of fresh streams and after said addition makes it possible to regulate the temperature of the hot effluent from the burner. The first system for monitoring the temperature before the addition of the fresh stream is connected to the system for distribution of the primary combustion air. It makes it possible to obtain effective combustion and a combustion temperature of generally approximately 900° C. The second system for monitoring the temperature after the addition of the fresh stream is connected to the system for distribution of the fresh stream, preferably air. It makes it possible to regulate the temperature of the effluent gas from the hot burner before the first heat exchanger.

In one variant of the process, a stream of water is vaporized in the second heat exchanger and then superheated in the first exchanger. Still according to this variant, the supply of air of the reforming reactor, when the reforming is autothermal, is done by adding the air stream to said water stream at two points: one between the second exchanger and the first exchanger, and the other between the first exchanger and the reforming reactor. The supply of air is monitored in a preferred way by a compressor/valve system that is connected to a temperature sensor located on the stream obtained from the reforming reactor. As a matter of fact, the addition of an oxygen source in the reforming reactor promotes the partial and total oxidation reactions of the hydrocarbon feedstock, which are exothermic. The distribution of this cold air between the first and second points of entry on the water stream is monitored in a preferred way by a valve that is connected to a temperature sensor located at the inlet of the reforming reactor. In this manner, the temperature at the inlet of the autothermal reformer preferably does not exceed the self-ignition temperature of the fuel.

The process according to this invention thus has the following advantages:
Monitoring of the temperature of the synthetic gas exiting the feedstock-effluent exchanger by operation in co-current, temperature of between 250 and 400° C., and preferably between 300 and 350° C.,
Keeping the temperature of the synthetic gas exiting the feedstock-effluent exchanger, by co-current operation even during the transient phases, between 250° C. and 400° C., and preferably between 300° C. and 350° C.,
Independent monitoring of the O₂/C ratio in the water-feedstock mixture for limiting coking during the vaporization of the feedstock by dedicated water intake,
Recovery of the heat produced by the WGS reaction that can be adapted based on the CO content and independently of the overall water supply by a dedicated water intake. As a matter of fact, according to the performance levels of the reformer, the CO content is variable. The WGS reaction is exothermic. The fact of having a water stream that can be modulated in the exchanger at the WGS outlet makes it possible to recover the heat that is produced by the WGS reaction based on the CO content.

This process also makes it possible to avoid the following problems, encountered in processes of the art that do not use a co-current heat exchange stage:
A cooling of the gaseous effluent (synthetic gas) below its condensation point (dew point of the mixture) that causes the appearance of liquid condensates; in particular, the presence of liquid water can cause a physical or chemical alteration of the active phases of the WGS catalyst. In addition, these condensates are potentially corrosive based on the nature of the feedstock and in particular its sulfurization level,
A cooling of the gaseous ATR effluent such that its temperature is not sufficient to activate the catalytic reactions that are necessary for continuing the treatment of the synthetic gas and for beginning to purify it, like the conversion reaction of carbon monoxide (WGS, for Water Gas Shift according to the English terminology), for example,
During the start-up or shutdown of the installation, there is a risk of cooling and condensation in the catalytic elements that can damage the latter, for example, either by chemical action of the condensate or by damage linked to the rapid climb in temperature without having been able to suitably dry the catalyst substrate.

### BRIEF DESCRIPTION OF THE DRAWING

The FIGURE represents a schematic drawing of an embodiment of the process of the invention.

### EXAMPLE OF IMPLEMENTATION OF THE PROCESS ACCORDING TO THE INVENTION

In the process according to the invention, the vaporeforming unit, illustrated in FIG. 1, is supplied with hydrocarbon feedstock and, for example, ethanol via a pipe for circulating ethanol (100) by a pump (1000) for producing a liquid and pressurized feedstock that circulates via a liquid feedstock pipe (101). The vaporeforming unit is supplied with pressurized water via a pipe for circulating water (200) at a temperature that is close to ambient temperature. The vaporeforming unit is also supplied with air via the air pipe (300), which is brought to the pressure of the process by a compressor (1012) and circulates at the desired pressure via a pressurized air pipe (301). The unit is supplied with air via a second air pipe (311) that supplies the burner (1009) to ensure the combustion of the latter. The primary air that is used for the burner circulates via the primary air pipe (310) and is pressurized by a fan (1010). Secondary air that circulates via a secondary air pipe (320) is pressurized by a second fan (1011). This pressurized secondary air stream that circulates via the pressurized secondary air pipe (321) makes it possible to monitor the temperature of the smoke that is obtained from the burner and that circulates via the smoke pipe (600).

The unit produces a stream of pressurized hydrogen (H₂) that circulates via the hydrogen pipe (500), with a smoke stream circulating via the cooled smoke pipe (603) and an aqueous purge that circulates via the aqueous purge pipe (702).

The supply of heat intended to condition the streams for supply of water and air of the process is provided by combustion of the aqueous purge that circulates via the purge pipe (406) that is obtained from the hydrogen purification device by alternate adsorption-desorption on the solid bed by pressure variation (PSA, pressure swing adsorption) (1008). The smoke stream that is produced circulates via the smoke pipe (600), whose temperature is adjusted by addition of the pressurized secondary air stream that circulates via the pressurized secondary air pipe (321), and makes it possible, on the one hand, to ensure the superheating of the air-vapor mixture that circulates in the air-vapor pipe (209) but also the vaporization of the water stream No. 3 that supplies the process and that circulates via the water pipe No. 3 (203) by means of, respectively, heat exchangers No. 1 (1014) and No. 2 (1015). The result is a stream of cooled smoke circulating via the cooled smoke pipe (603) evacuated via an air vent or a chimney (1016).

The detailed scheme that leads to the production of hydrogen is as follows. A stream No. 1 of water that circulates via a water pipe No. 1 (201) that is obtained from the pipe for circulating water (200) by means of a water stream separator (1001) is added to the pressurized feedstock stream that circulates via the liquid feedstock pipe (101). This addition of water to the feedstock has the purpose of being able to monitor, i.a., the ratio of oxygen to carbon (O₂/C) of the stream that results from the mixture of the liquid feedstock and the water stream and that circulates via the feedstock-water mixture pipe (102). The coking or not of the feedstock in the heat exchanger (1002) depends on this ratio (O₂/C). Based on the feedstock, pressures and temperatures of the process, a minimum O₂/C ratio can be defined. The resulting stream of the mixture of the liquid feedstock and the water stream that circulates via the feedstock-water mixture pipe (102) whose temperature is less than its boiling point, and, for example, between 140 and 200° C. at a pressure of 0.9 MPa (variable according to the selected water content), is to be vaporized before supplying, via the vaporized feedstock-water pipe (103), the ATR reactor (1003) that produces the synthetic gas that circulates via the synthetic gas pipe (400). Furthermore, this pressurized synthetic gas that circulates via the synthetic gas pipe (400) produced by the ATR reactor (1003) is to be cooled rapidly to prevent the phenomenon of “catastrophic carburation”-type corrosion (“metal dusting” according to the English terminology). For this purpose, the streams that circulate via the feedstock-water mixture pipe (102) and the synthetic gas pipe (400) are introduced into the heat exchanger (1002) in co-current configuration.

In the case of a gaseous hydrocarbon feedstock, for example natural gas, the same overall configuration is used. Only the mixing point of the feedstock in the circuit differs. As a matter of fact, in the case of a gaseous feedstock, the water stream (201) is injected by itself into the co-current heat exchanger (1002) and is therefore used without direct contact with the gaseous feedstock (not illustrated) that will be mixed with the vapor formed downstream from the co-current heat exchanger (1002) in the vaporized water-feedstock pipe (103) and upstream from the ATR (1003).

The result is a vaporized and superheated feedstock stream that circulates via the vaporized feedstock-water pipe (103) and a stream of cooled synthetic gas that circulates via the cooled synthetic gas pipe (401). The cooling is such that the cooled synthetic gas that circulates via the cooled synthetic gas pipe (401) remains at a temperature that is higher than its dew point, in general between 128° C. and 168° C., and preferably equal to 148° C. at a pressure of 0.88 MPa. With the heat exchanger (1002) being designed for total vaporization of the feedstock, the temperature conditions on the streams circulating via the vaporized feedstock-water pipe (103) and the cooled synthetic gas pipe (401) are monitored by the flow rate monitor of the water stream circulating via a water pipe No. 1 (201) provided that the minimum O₂/C ratio is ensured. The monitoring of the flow rate of water injected at the heat exchanger (1002) is possible owing to the use of three parallel circuits for the vaporization of the complete stream of water circulating in the water pipe (200). For the good operation of the reforming reactions in the ATR reactor (1003), the latter, in addition to being supplied by the vaporized feedstock circulating via the vaporized feedstock-water pipe (103), is to be supplied by a mixture of air and vapor that circulates in the air-vapor pipe (209). The result is a mixture of vaporized feedstock, air, and vapor that circulates in the air-vapor mixture pipe (104) that is to consist as much as possible of the catalytic elements of the ATR reactor (1003) so as to prevent the self-ignition phenomena. These catalytic elements are, for example, catalysts that are suitable for reforming the selected ATR feedstock that is supported on inert ceramic monoliths. The result is a hot and pressurized synthetic gas that circulates in the synthetic gas pipe (400).

The good operation of the ATR process is contingent, based on the nature of the feedstock, on a given vapor to carbon ratio (S/C, steam over carbon ratio) that in general is between 2 and 5. The S/C ratio is monitored by the total flow rate of the supply of water of the process that circulates in the water circulation pipe (200). Since this flow rate is greater than that of the water attached to the feedstock and circulating in the water pipe No. 1 (201), it is advisable to provide it separately. A second fraction that circulates in the water pipe No. 2 (202) for water supply is thus constituted. This second water fraction is provided in vapor form by recovering the heat that is produced by the WGS reaction carried out in the WGS reactor (1004) by means of a WGS heat exchanger (1005). A third fraction that circulates in the water pipe No. 3 (203) of the supply is also created. This third water fraction is provided in the form of vapor that circulates in the second vapor pipe (205) by recovering the heat that is produced by the smoke that circulates in the second smoke pipe (602) by means of the smoke heat exchanger No. 2 (1015) for ensuring a good energy yield of the process. The result is a vapor stream circulating in the vapor pipe (204) that is obtained from the WGS heat exchanger (1005) and a second circulating in the second vapor pipe (205) that is obtained from the smoke heat exchanger No. 2 (1015). The monitoring of the distribution of the flow rates of these two vapor streams makes it possible to optimize the recovery of the heat that is obtained from the WGS reactor (1004) without producing a condensation of the synthetic gas. Another important parameter of the operation of the reforming process according to the invention is the addition of oxygen in the reaction medium. The latter will monitor the addition of heat by oxidation of a portion of the feedstock and/or the synthetic gas. This addition depends on the way in which energy that is obtained from the process can be recovered: recovery of heat in the WGS reactor (1004) or recovery of heat obtained from the combustion of the purge of PSA (1008). The addition of oxygen is done primarily by the air that circulates in the pressurized air pipe (300) of the process by a compressor (1012) and that circulates at the desired pressure via the pressurized air pipe (301). This air stream is partially sent via the second air pipe (302) that comes from an air distributor (1013) for constituting a first mixture, circulating in the vapor-air mixture pipe (207) with the vapor circulating in the third vapor pipe (206) that is the continuation of the vapor pipe (205) that comes from the smoke heat exchanger No. 2 (1015), which will be superheated via the smoke heat exchanger No. 1 (1014) by the heat that is extracted from the smoke that circulates in the smoke pipe (601) obtained from the burner (1009). The result is a stream of partially cooled smoke circulating in the second smoke pipe (602) obtained from the heat exchanger No. 1 (1014). The remainder of the air that circulates in the third air pipe (303) that is obtained from the distributor (1013) is added to the air-vapor mixture that circulates in the air-vapor pipe (208) that comes from the smoke heat exchanger No. 1 (1014); the thus formed mixture circulates in the air-vapor pipe (209). The distribution by the distributor (1013) of the air between the streams circulating in the pipes (302) and (303) is carried out in such a way that the mixture of the air circulating in the pipe (302) with the vapor circulating in the pipe (206) does not produce the condensation of the latter.

The stream of hot synthetic gas circulating in the pipe (400) and produced by the reforming of the feedstock in the ATR reactor (1003) is cooled in the co-current exchanger (1002) and circulates in the cooled synthetic gas pipe (401). Its exit temperature is in general between 300 to 350° C., which is sufficient to activate the WGS reaction to which it will be subjected in the WGS reactor (1004). As a matter of fact, the synthetic gas that is obtained from the ATR reforming of the ethanol can comprise high contents of carbon monoxide (CO), in general less than or equal to 10 mol %. However, it is possible to maximize the amount of hydrogen produced by conversion of 1 mol of CO and 1 mol of water (H₂O) into 1 mol of carbon dioxide (CO₂) and 1 mol of H₂ by WGS reaction. This reaction is exothermic; the temperature of the synthetic gas that is low in CO circulating in the pipe of depleted synthetic gas (402) (on the order of 1% of CO remains) is higher, generally between 0 and 40° C., and preferably between 20 and 30° C., than the temperature of the synthetic gas that circulates in the inlet pipe of the WGS reactor (401). This synthetic gas is to be cooled by means of a heat exchanger (1006) and dehydrated by a separator flask (1007) before its input into the PSA (1008); and the heat is recycled by vaporization of a portion of the supply of water circulating in the water pipe No. 2 (202) in the WGS heat exchanger (1005). The cooled synthetic gas that circulates in the cooled synthetic gas pipe (403) is brought below its condensation point (404), i.e., in general to a temperature of between 15 and 40° C., in the heat exchanger (1006) that can be coupled to a cold group (not shown) before being separated from the residual water that circulates in the residual water pipe (700) by a separator flask (1007). The flask (700) can be completed by a coalescer (not shown) to improve the effectiveness of the elimination of water in the synthetic gas. The water thus recovered is either recycled into the recycling pipe (701) after retreatment (not shown) or purged from the unit in the purge pipe (702).

The hydrogen that circulates in the hydrogen pipe (500) is produced after the synthetic gas passes into the PSA (1008) in which almost all the radicals other than H₂, typically and non-exhaustively those present in the air or co-produced by the reforming of ethanol, namely N₂, CO, CO₂, CH₄, C₂H₄, C₂H₆, C₃H₈, C₃H₆, Ar or H₂O, are reversibly adsorbed on the adsorbent solid bed of PSA (1008) (which is in general but not exclusively activated carbon and/or a mineral molecular sieve). The hydrogen is not retained and is produced with a very high purity, with the impurities being reduced to the trace state, in general less than 500 ppm. The adsorbed radicals are recovered via the purge pipe (406) by lowering the pressure of the chamber of the PSA (1008) from the pressure of the process to a pressure that is close to atmospheric pressure producing the reduction of the partial pressure of each element in the gas phase and therefore the desorption of the adsorbed radicals. This low-pressure gas stream that circulates in the purge pipe (406) is the purge of the PSA (1008).

This purge that circulates in the purge pipe (406) also contains a significant portion of combustible gases such as CO, H₂. The purge is then burned with air, circulating in the air pipe (311), in the burner (1009) in such a way as to provide hot smoke that circulates in the smoke pipe (600) designed to recycle the heat in the process. The temperature of this smoke is controlled by the supply of secondary air circulating in the pressurized secondary air pipe (321) so that the smoke in the smoke pipe (601) obtained from the burner (1009) sent toward the process is compatible with the metallurgy of the system.

The following examples illustrate the process according to the prior art and according to the invention.

### EXAMPLES

### Comparison Example 1

### Counter-Current Configuration

This example illustrates a case of normal operation of the process according to the prior art.

The process according to the prior art uses a configuration of the heat exchanger, coupled to the ATR reactor, in counter-current. It is described using FIG. 1 except for the feedstock-effluent exchanger (1002) that is in a co-current configuration in the process according to the invention, contrary to that of Example 1, which is counter-current. This modification does not affect the designation of the streams in FIG. 1.

The conversion of a stream of 29.2 kg/h of ethanol circulating in the pipe (100) is considered. It is mixed with a stream of liquid water (201) of 37 kg/h. This liquid feedstock enters into the exchanger (1002) at a temperature that is close to the ambient temperature, which is 35° C.

The stream (400) exiting the ATR reactor (1003) is the result of the high-temperature catalytic conversion, here 690° C., and, at a pressure of 0.88 MPa, of the vaporized feedstock that circulates in the pipe (201) to which a supplement of vapor (206) of 56.6 kg/h and a supplement of air circulating in the pipe (301) of 54.8 kg/h are added. A synthetic gas that circulates in the pipe (400) at 690° C. of the following composition is obtained:

| Compound | Mol % |
|---|---|
| Hydrogen (H₂) | 25.1 |
| Methane (CH₄) | 1.1 |
| Nitrogen (N₂) | 15.3 |
| Carbon Monoxide (CO) | 3.3 |
| Carbon Dioxide (CO₂) | 9.3 |
| Water (H₂O) | 45.9 |

The dew point of this gaseous effluent at 0.88 MPa is 148° C.

The following table provides inlet and outlet temperatures of the different fluxes around the exchanger (1002) in counter-current configuration.

| Flux | Temperature (° C.) |
|---|---|
| ATR Outlet (400) | 690 |
| WGS Inlet (401) | 166 |
| Liquid Feedstock (102) | 35 |
| Vaporized Feedstock (103) | 507 |

It is noted that the temperature of the cooled synthetic gas that circulates in the pipe (401) is 166° C., which is close to its dew point (148° C.), and that the temperature of the vaporized feedstock that circulates in the pipe (103) is 507° C., which is too high to prevent the risks of self-ignition effectively at the inlet of the reforming reactor during the mixing of the vaporized feedstock (103) with the air that circulates in the pipe (209) to enter via the pipe (104) into the reactor (1003).

Furthermore, the temperature of the cooled synthetic gas that circulates in the pipe (401) should be sufficient to initiate the reaction for converting carbon monoxide (WGS) with satisfactory kinetics or at 166° C.; essentially below 200° C. is required and broadly below 250° C. is desirable. The consequence of the WGS reactor (1003) not operating is that the residual CO is not converted into H₂, which can lead to a significant loss of hydrogen yield that can reach 10%.

With regard to the high inlet temperature in the reactor (1003), it is preferable to remain below a temperature on the order of 450° C. to prevent self-ignition. The consequence of self-ignition is a threat to the safety of the operator and the unit and imposes an emergency shutdown.

Finally, in this counter-current configuration, very high wall temperatures are encountered since the hot synthetic gas that circulates in the pipe (400) exchanges heat with the vaporized feedstock that circulates in the pipe (103) for the respective temperatures of 690° C. and 507° C. The wall temperature in this configuration is beyond 600° C. This temperature imposes high thermomechanical stresses on the material and also places it under metal dusting conditions that are able to damage the exchanger.

### Example 2 According to the Invention

### Co-Current Configuration

This example illustrates a case of normal operation of the process of the invention.

The exchanger being considered is identical to the exchanger of Example 1, but it is mounted in co-current configuration instead of counter-current.

In the same way as in Example 1 the conversion of a stream of 29.2 kg/h of ethanol drives the circulation of ethanol circulating in the pipe (100) [sic]. It is mixed with a stream of liquid water that circulates in the pipe (201) of 37 kg/h. This liquid feedstock enters the exchanger (1002) at a temperature that is close to the ambient temperature, here 35° C.

The stream that circulates in the pipe (400) and that exits the ATR reactor (1003) is the result of the high-temperature catalytic conversion, here 690° C., and, at a pressure of 0.88 MPa, of the vaporized feedstock that circulates in the pipe (201) to which a supplement of vapor circulating in the pipe (206) of 56.6 kg/h and a supplement of air circulating in the pipe (301) of 54.8 kg/h are added. Here again, a synthetic gas is obtained that circulates in the pipe (400) at 690° C. with the following composition:

| Compound | Mol % |
|---|---|
| Hydrogen (H₂) | 25.1 |
| Methane (CH₄) | 1.1 |
| Nitrogen (N₂) | 15.3 |
| Carbon Monoxide (CO) | 3.3 |
| Carbon Dioxide (CO₂) | 9.3 |
| Water (H₂O) | 45.9 |

The dew point of this gaseous effluent at 0.88 MPa is 148° C.

The following table provides inlet and outlet temperatures of the different fluxes around the exchanger (1002) in co-current configuration.

| Flux | Temperature (° C.) |
|---|---|
| ATR Outlet (400) | 690 |
| WGS Inlet (401) | 274 |
| Liquid Feedstock (102) | 35 |
| Vaporized Feedstock (103) | 269 |

The consequence of co-current operation is the convergence of exit temperatures circulating in the pipe (401) and in the pipe (103) of the exchanger (1002).

The temperature of the cooled synthetic gas is 274° C., which is most particularly suitable for the conversion reaction of carbon monoxide that has to have taken place in the reactor (1004) for which it is suitable to have an inlet temperature of between 250 and 300° C.

The temperature of the vaporized feedstock that circulates in the pipe (103) is 269° C., which makes it possible to have a temperature of the mixture that circulates in the pipe (104) with the air and the superheated vapor circulating in the pipe (103) on the order of 400° C. This temperature is completely suitable for a securing operation of the ATR reactor (1003).

Furthermore, with regard to the wall temperature of the exchanger (1002), the most heavily stressed zone is always the one where the hot synthetic gas that circulates in the pipe (400) is introduced, unlike Example 1 where the wall is in contact with the liquid feedstock that circulates in the pipe (102); this makes it possible to keep a wall temperature below 400° C. and therefore to limit the thermomechanical stresses, but also to keep it outside of the metal dusting zone.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

The entire disclosures of all applications, patents and publications, cited herein and of corresponding French application Ser. No. 10/05020, filed Dec. 22, 2010, are incorporated by reference herein.

From the foregoing description, one skilled in the art can easily ascertain the essential characteristics of this invention and, without departing from the spirit and scope thereof, can make various changes and modifications of the invention to adapt it to various usages and conditions.

1. Process for producing thermally-integrated hydrogen by reforming a hydrocarbon feedstock, in a reforming reactor, comprising a stage for maintaining the temperature of the effluent that is obtained from the reforming reactor by co-current heat exchange, in a co-current heat exchanger, between the effluent that is obtained from the reforming reactor and the hydrocarbon feedstock that it is desired to reform, comprising a stage in which the reformate that is obtained from the co-current heat exchanger is purified in a purification section for generating a hydrogen gas whose purity is greater than 99% and in which:
A first stream of water is directed toward the co-current heat exchanger, making it possible to evaporate it while recovering a portion of the enthalpy of the synthetic gas that is produced for monitoring the temperature of the feedstock stream,
A second stream of water is directed toward a heat exchanger downstream from the reactor for conversion reaction of carbon monoxide to recycle the exothermy of the reaction of the conversion reaction of carbon monoxide,
A third stream of water is directed toward a heat exchanger for recovery of the heat obtained from combustion smoke while reducing the exit temperature of this smoke as much as possible.

2. Process according to claim 1, wherein the temperature of the effluent after passing into the co-current heat exchanger is between 250° C. and 400° C.

3. Process according to claim 2, wherein a portion of the purification is carried out with a reaction for conversion of carbon monoxide.

4. Process according to claim 3, wherein the first water stream is brought into direct contact with the stream of the feedstock upstream from the exchanger when the feedstock is liquid.

5. Process according to claim 4, wherein the first vaporized water stream is brought into contact with the stream of the feedstock downstream from the co-current exchanger and upstream from the reforming reactor when the feedstock is gaseous.

6. Process according to claim 1, wherein the hydrocarbon feedstock is liquid.

7. Process according to claim 1, wherein the hydrocarbon feedstock is ethanol.

8. Process according to claim 1, wherein the hydrocarbon feedstock is gaseous.

9. Process according to claim 1, wherein the hydrocarbon feedstock is natural gas.

10. Process according to claim 1, wherein the reforming reaction is an autothermal reforming.

11. Process according to claim 10, wherein the water that is contained in the hydrogen-rich gas that is obtained from the reforming reactor is eliminated using a condenser that is located in the purification section.

12. Process according to claim 11, wherein the water that is collected in the condenser is recycled in the process.

13. Process according to claim 11, wherein the water that is collected in the condenser is sent into the reforming reactor to be used as a reagent of the vaporeforming reaction.

14. Process according to claim 11, wherein residual gases that are released by the purification section are used as fuel for the burner.
